(19) United States
(12) Patent Application Publication
(10) Pub. No.: US 2016/0145156 A1
(43) Pub. Date: May 26, 2016

(54) PREPARATION PROCESS OF THE METAMATERIAL WITH NEGATIVE INDEX OF REFRACTION

(71) Applicant: INSTYTUT NISKICH TEMPERATUR I BADAN STRUKTURALNYCH PAN IM, Wroclaw (PL)

(72) Inventors: Karen OGANISIAN, Wroclaw (PL); Wieslaw STREK, Bielany Wroclawskie (PL); Andrej VOGT, Wroclaw (PL); Pawel GLUCHOWSKI, Kamienna Gora (PL)

(73) Assignee: Instytut Niskich Temperatur I Baden Strukturalnych Pan IM, Wroclaw (PL)

(21) Appl. No.: 14/901,632

(22) PCT Filed: Jun. 25, 2014
(86) PCT No.: PCT/PL14/00069

§ 371 Date: Dec. 28, 2015

(30) Foreign Application Priority Data
Jul. 2, 2013 (PL) PL404538

(51) Int. Cl. C04B 35/583; C04B 35/64; C04B 35/628; C04B 35/626

(52) U.S. Cl. CPC C04B 35/583; C04B 35/6261; C04B 35/62695; C04B 35/64; C04B 35/62836; C04B 2235/405

(57) ABSTRACT

There is a preparation process of the metamaterial with a negative index of refraction, especially the lefthanded composite system (ceramic) built from iron and boron nitride Fe:BN with a negative refractive index associated with negative values of the magnetic −μ and dielectric −£ permeability. Method of preparation of the Fe:BN ceramic includes mixing Fe nano or micro particles (synthesized from iron pentacarbonyl Fe(CO)s) with hexagonal boron nitride (h-BN), grinding the powders, compacting the powder in form of pellets at room temperature and low pressure, placing a pellet in a container (CaCO3) with graphite heater, and sintering the pellet from ambient pressure to 8 GPa and temperature from room temperature to 2000 degrees C. The iron or iron based powder particles are evenly distributed in h-BN media and form core-shell structure, where the core includes iron or iron based particles and the shell includes an h-BN layer.

### CROSS-REFERENCE TO RELATED APPLICATIONS

See also application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The invention concerns a new metamaterial (ceramic) with negative index of refraction in range from 1 MHz to 1 GHz. Particularly, the invention concerns a preparation process of the ceramics having negative values of the magnetic −μ and dielectric −£ permeability and its application.

2. Description of Related Art Including Information Disclosed Under 37 CFR 1.97 and 37 CFR 1.98.

The author of theory of the electrodynamics of negative refraction materials, V. Veselago has predicted and even performed an attempt to obtain a natural material with the negative refractive index [V. Veselago, Soviet Physics Uspekhi, 10 (1966) 509). But until now only few materials obtained by chemical route had metamaterial properties [A. Pimenov, A. Loidl, K. Gehrke, V. Moshnyaga, K. Samwer, Physical Review Letters, 98 (2007) 197401, Z. Shi, R. Fan, Z. Zhang, K. Yan, X. Zhang, K. Sun, X. Liu, C. Wang, Journal of Materials Chemistry C, 1 (2013) 1633). Usually metamaterials are artificial, periodic structures allowing to modulate the electromagnetic wave with changing of the geometry of its unit cells. The first perfect metamaterial absorber, having the measured absorptivity of about 88%, composed of a metallic split ring and a cut wire separated by a dielectric layer was demonstrated by Landy et al. [N. I. Landy, S. Sajuyigbe, J. J. Mock, D. R. Smith, W. J. Padilla, Physical Review Letters 100 (2008) 207402]. Since then, metamaterials have received considerable attention and many absorbers have been proposed [B.-X. Wang, L.-L. Wang, G.-Z. Wang, W.-Q. Huang, X. Zhai, X.-F. Li, Optics Communications, 325 (2014) 78, C. Sabah, F. Dincer, M. Karaaslan, E. Unal, O. Akgol, E. Demirel, Optics Communications, 322 (2014) 137].

One of the most important parameters characterizing a negative index metamaterial (NIM) is the refractive index. It is noteworthy that the metamaterials have frequency dispersion therefore they demonstrate their extraordinary properties in a limited frequency range. So the frequency range where metamaterials exhibit negative values of refractive index is one of the key factors characterizing NIM.

For Fe:BN ceramics, dielectric and magnetic permeability measurements in function of the frequency (1-1000 MHz) were made. Measurements have been carried out for several samples with different Fe to BN ratios and sintered under various conditions. It was found that all Fe:BN ceramics have a negative real part of the dielectric and magnetic permeability over a wide frequency range (10 to 1000 MHz). On the basis of the measurements it was showed that in the studied materials the refractive index in the relevant frequency range has a negative value. A similar effect is observed mainly in artificially derived materials (where with different methods are produced periodic structures), and very rarely occurs in natural materials (where periodic structures are not introduced intentionally). For example, in the U.S. Pat. No. 6,791,432 describe composite having simultaneous negative effective permittivity and permeability over a common band of frequencies where medium is composed of periodically assembled elements where some are responsible for negative values of the magnetic permeability and the other for negative values of dielectric permittivity. In other patent (no US 20070273055) metamaterial is composed of microstructured material comprising one or more elongate voids running substantially the length of the sample, where the liquid is introduced under high pressure and the liquid comprising at least one semiconductor carried in at least one carrier fluid. In U.S. Pat. No. 8,271,241, metamaterial is composed of dielectric substrate, wherein each of the discrete resonators has a shape that is independently selected from: a F-type shape; an E-type shape; or an y-type shape. These examples show that for obtaining metamaterials the complicated processes are needed for producing periodic structures.

It is extremely important that Fe:BN ceramics exhibits properties similar to artificial metamaterials, while being a natural material. Additionally, operating range of the Fe:BN ceramic is much broader than for artificial metamaterials (that exhibit their properties for a very narrow frequency values), so it can be adapted to individual solutions.

### BRIEF SUMMARY OF THE INVENTION

Metamaterial is an artificial structure where the refractive index at specified frequency range have a negative value, which is associated with the simultaneous appearance of the negative values of the magnetic −μ and dielectric −£ permeability. This phenomena is not observed in any known natural material. Metamaterials are particularly important in optics and photonics, where their properties allow to produce new types of lenses, antennas, modulators and filters. For preparing such an artificial structure, very complicated and expensive processes are needed. Each element within an array of metamaterial (Negative index of refraction material MM) elements comprises multiple loops and at least one gap. This allows manipulation of electromagnetic radiation.

A preparation process of the metamaterial with a negative index of refraction is provided including the steps of: die compacting a powder composition including a mixture of nano or microsized iron or iron-based particles and hexagonal boron nitride (h-BN); and heating and pressing the compacted body in specified atmosphere to a temperature and a pressure below the decomposition temperature/pressure of the iron and or iron-based powder.

### BRIEF DESCRIPTION OF THE SEVERAL VIEWS OF THE DRAWINGS

The invention will be more fully understood by reference to the following drawings which are for illustrative purposes.

FIG. 1 shows the schematic view of the system which was used for preparation of metamaterial ceramic as “Green body” means cold pressed pellet.

FIG. 2 shows a schematic illustration of the flowchart of manufacturing the Fe:BN ceramic metamaterial

FIG. 3 is a schematic illustration of a graph characterizing dielectric permittivity of the Fe:BN ceramics in the frequency range from 10 to 1000 MHz.

FIG. 4 is a schematic illustration of a graph characterizing magnetic permittivity of the Fe:BN ceramics in the frequency range from 10 to 1000 MHz.

FIG. 5 is a schematic illustration of a graph of frequency-dependent refractive index calculated for Fe:BN ceramic.

FIG. 6 is a TEM image of core shell structure of Fe:BN ceramic.

### DETAILED DESCRIPTION OF THE INVENTION

The present invention concerns a preparation process of the metamaterial with negative index of refraction comprising the steps of;

Grinding a powder composition comprising a mixture of iron or iron-based particles (core) and hexagonal boron nitride, h-BN (shell),

The core particles are surrounded by an insulating, inorganic coating in an amount of 1 to 35 weight %

Cold pressing into a pellet at room temperature

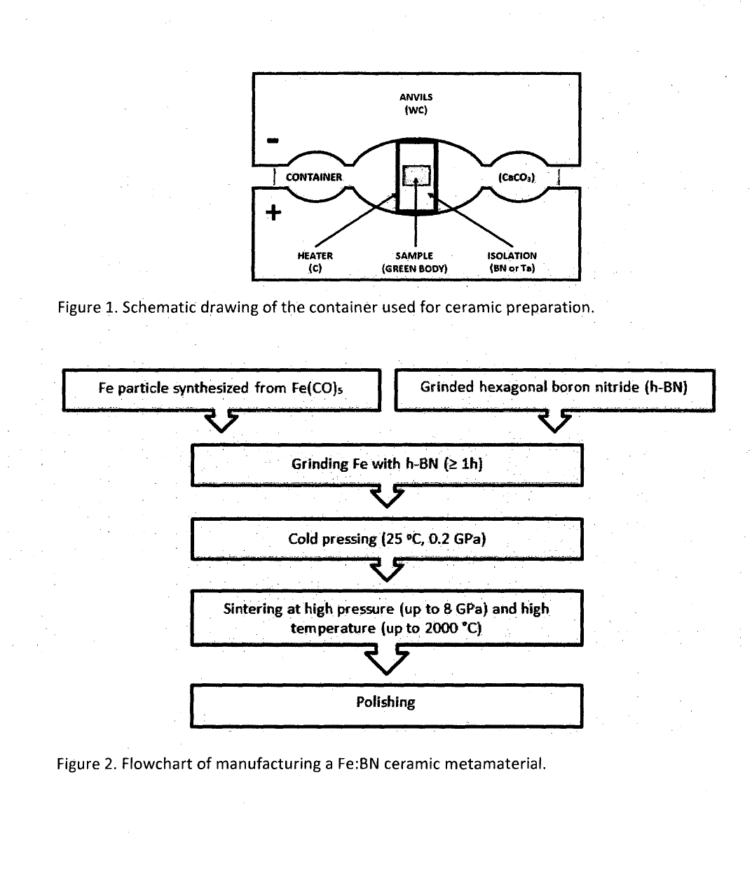

Placing the pellet in a container with graphite heater (FIG. 1)

Sintering the compacted powder in a non reducing atmosphere to the pressure and temperature below the decomposition conditions of the iron or iron-based powder.

Flowchart of manufacturing a Fe:BN ceramic metamaterial is showed in FIG. 2.

According to the present invention, the metamaterial composed of iron or iron based material and hexagonal boron nitride is prepared. Preferably the powder comprises nanosized carbonyl iron or essentially pure iron. Preferred insulating layer that can be used according to the invention is the fine powder of the hexagonal boron nitride (h-BN).

The type of insulator used in iron or iron based powder is important one and h-BN is selected due to its ability to thoroughly coating the iron or iron based powder particles by thin layer that significantly improving the corrosion resistance of obtained materials. Using h-BN as binder in sintering process allows to exclude other additives at all leading to increasing of homogeneity in the ceramic.

The sintering may be performed between 0.2 and 8 GPa and from room temperature to 2000° C. If sintering is performed at pressures below 2 GPa and/or at temperatures below 1200° C. then ceramics may have reduced strains. If compaction is performed at conditions corresponding to decomposition of iron particles or h-BN then insulating layer may be destroyed.

There is an ability to add another lubricant such as titanium dioxide, graphite, graphene, silicon carbide, rare earth metals and d-block elements. Adding of mentioned materials allows to control the hardness, electric resistivity and magnetic properties of obtained ceramics.

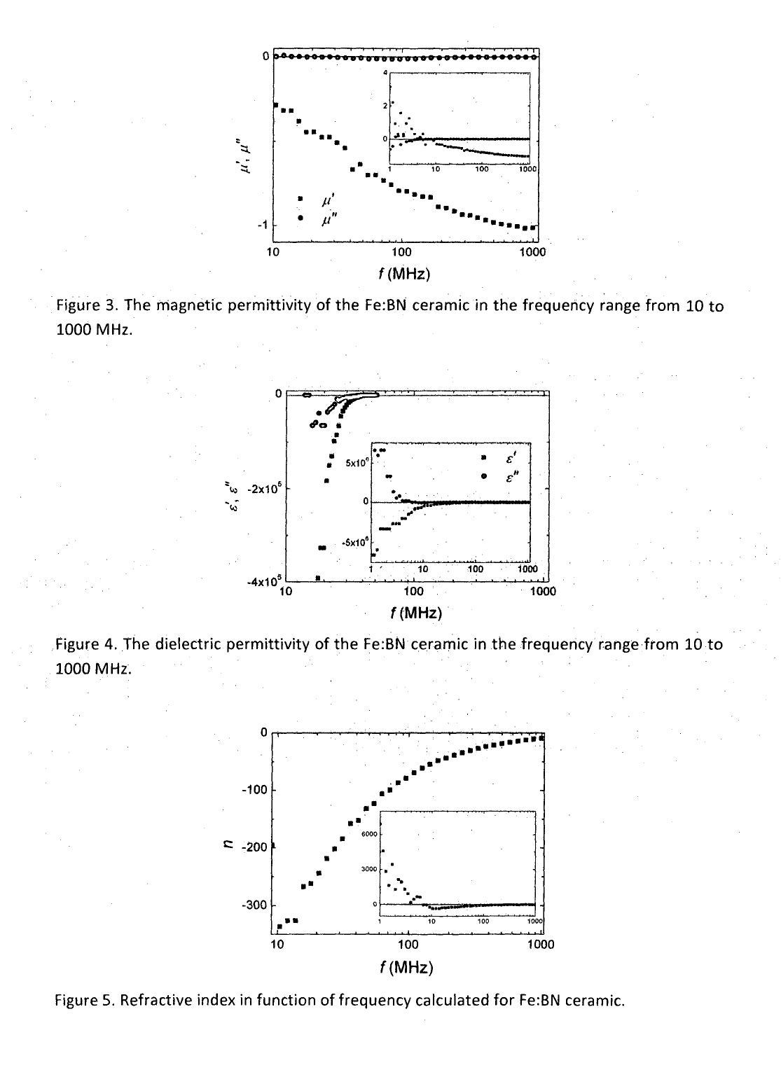

As can be seen from the following examples ceramic having metamaterial properties as negative values of the magnetic −μ (FIG. 3), dielectric −£ permeability (FIG. 4) and refractive index (FIG. 5) can be obtained by the method according to the invention.

### EXAMPLES

The examples below are non-limiting and are merely representative of various aspects and features of the present invention.

### Example 1

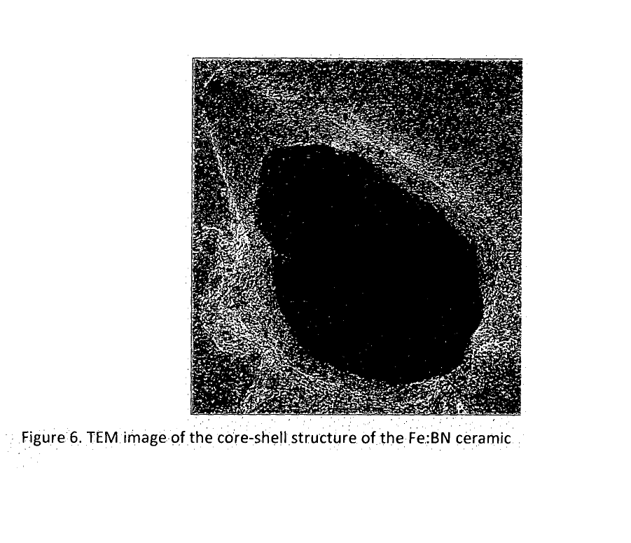

Iron (Fe) synthesized from iron pentacarbonyl Fe(CO)5 is mixed with milled hexagonal boron nitride (h-BN) in a molar ratio Fe:BN 7:1. Then the mixture of Fe:BN is grinded in an agate mortar for one hour. Fine grinded material is pressed at room temperature under a pressure of 0.2 GPa. Thus compacted material in the form of pellet is placed in a container (CaCO3) with a graphite heater inside and is sintered at 8 GPa and 1450° C. The ceramic after sintering is polished. The XRD patterns of the obtained ceramics don't show any peaks characteristic for oxygen, iron oxides or other compounds with oxygen. The transmission electron microscopy (TEM) images indicate the formation of the of the core-shell structure (FIG. 6), where the iron particles (core) are effectively surrounded by several layers of boron nitride (shell).

The obtained Fe:BN ceramic composite has a negative value of magnetic permittivity in the range from 1 MHz to 1 GHz (FIG. 3) and negative values of the dielectric permeability at frequencies from 1 MHz to 1 GHz (FIG. 4).

### Example 2

Iron (Fe) synthesized from iron pentacarbonyl Fe(CO)5 is mixed with milled hexagonal boron nitride (h-BN) in a molar ratio Fe:BN 17.5:1. Then the mixture of Fe:BN is grinded in an agate mortar for one hour. Fine grinded material is pressed at room temperature under a pressure of 14 kN. Then the compacted material in the form of pellet is heated to 1000° C. with heating step 15° C./min for 67 min and then cooled for in a few hours. The resulting compound has a negative value of dielectric permittivity in the range from 1 MHz to 1 GHz and negative values of the magnetic permeability at frequencies from 11 MHz to 1 GHz. As a result it is possible to obtain a Fe:BN ceramic composite with metamaterial properties, with a negative refractive index at frequencies above 11 MHz.

The invention claimed is:

1. A method of preparation of an Fe:BN ceramic composition, said method comprising the steps of:
mixing of Fe nano or micro particles, wherein the particles are synthesized from iron pentacarbonyl Fe(CO)5) with hexagonal boron nitride (h-BN) so as to form powders;
grinding said powders;
compacting said powder into pellets at room temperature and low pressure;
placing a pellet in a container (CaCO3) with graphite heater; and
sintering said pellet at pressure from ambient pressure to 8 GPa and at temperature from room temperature to 2000° C.).

2. The method according to claim 1, wherein each powder has the iron or iron based powder particles evenly distributed in h-BN media and comprised of a core and a shell structure, wherein said core comprises an iron or iron based particles, and wherein said shell structure comprises an h-BN layer.

3. The method according to claim 1, wherein the step of grinding lasts at least 1 hour.

4. The method according to claim 1, wherein the step of compacting comprises cold pressing each pellet at room temperature.

5. The method according to claim 4, wherein the step of cold pressing is done from 0.1 to 0.2 GPa.

6. The method according to claim 1, wherein the step of sintering is from room temperature up to 2000° C.

7. The method according to claim 1, wherein the step of sintering is from 0.1 to 8 GPa.

8. The method according to claim 2, wherein the shell prevents oxidation of the iron or iron based particles.

9. The method according to claim 2, wherein the shell is comprised of efficiently separate iron or iron based particles.

10. The method according to claim 1, wherein the Fe:BN system have diamagnetic and dielectric properties in alternating field above 1 MHz.

11. The method according to claim 1, wherein the Fe:BN system has metamaterial properties in frequency range from 1 MHz to 1 GHz.

12. The method according to claim 1, wherein the obtained Fe:BN system in the frequency range from 1 MHz to 1 GHz has a negative value of the complex magnetic permeability and complex electric permittivity.

13. The method according to claim 1, wherein the Fe:BN system in the frequency range from 1 MHz to 1 GHz has negative index of refraction.

14. The method according to claim 1, wherein the Fe:BN system properties vary according to lower and higher frequency after changing process conditions or changing Fe to h-BN ratio.

15. The method according to claim 1, wherein the Fe:BN system above 1 MHz has a negative electromagnetic losses, allowing to produce energy working as an electromagnetic amplifier.
